(19) United States
(12) Patent Application Publication
(10) Pub. No.: US 2012/0025952 A1
(43) Pub. Date: Feb. 2, 2012

(54) IDENTIFICATION SYSTEM FOR HUMAN-MACHINE INTERFACE USING RADIO FREQUENCY AND IDENTIFICATION METHOD FOR THE SAME

(76) Inventors: Ching-Shiong Tsai, Taipei (TW); Ching-Yang Wu, Taipei (TW); Chia-Chun Lee, Taipei (TW)

(21) Appl. No.: 12/844,520

(22) Filed: Jul. 27, 2010

(51) Int. Cl. H04Q 5/22

(52) U.S. Cl. 340/10.1

(57) ABSTRACT

An identification method for a human-machine interface using radio frequency and an identification system using the method is disclosed. First, a computer senses a radio frequency identification (RFID) tag and compiles a password table according to tag number of the RFID tag. The computer downloads the password table to a human-machine interface (HMI) as the compilation completed. When the human-machine interface executes identification process, the HMI senses the RFID tag via a radio frequency card reader and looks up in the downloaded password table if any tag number matches with the sensed RFID tag is recorded. If yes, HMI uses the identification password corresponding to the tad number in the password table for executing identification process.

### BACKGROUND OF THE INVENTION

1. Field of the Invention

The invention relates to a human-machine interface and in particular relates to an identification system and an identification method for a human-machine interface.

2. Description of Prior Art

A human-machine interface (HMI), or a Human-machine Interface Device (HID) is a intermediate medium between operator and machine for performing information exchange. The operator uses control keys of the HMI or touch control icons of a touch control panel to trigger corresponding operations in order to make the machine control more convenient and practical. As a result, HMI makes the automatic industrial control a more convenient process. Further, HMI gradually replaces the conventional control panel which requires complicated wirings.

Currently, a HMI is used for controlling a plurality of machines and triggering serial operations or procedures of the machines and has significant impact on production lines. Therefore, it is desirable to perform strict controls over the HMI operations and assure that HMI operation is authorized. For example, different passwords are assigned with operating different authority levels to each operator and specific operations, such as tasks setting up critical system parameters or accessing to confidential data, require specific password for logging on to HMI. Thus, the operation confidentiality is improved and the risk of data leakage is reduced.

The HIM available in the market all utilize manual password input to perform the above mentioned operation control. Each operator has to manually input an identification password before operating on a HMI or switching to a specific operating screen in a HMI identification process. The operator is permitted to operate on the HMI or log on to specific operating screen of the HMI after the password input passes the identification process.

However, the above mentioned identification process using manual password input has the disadvantages described in the following:

1. When a user logs on to specific operating screen, the operation flow of the user is interrupted by manually input password, the user has to spend time on completing the password input step to move on with the operation flow which is inconvenient to the user.

2. An operator has to keep each password firmly in mind. In addition, if the operators is authorized with a plurality of passwords for logging on to a plurality of operating screens, the operator cannot log on to HMI and proceed with operations as scheduled once the operator forgets about the passwords;

3. Passwords may be eavesdropped to third party standing next to an operator when the operator manually input the password input.

To sum up, it is desired to provide an innovative identification system and method for an HMI to make an identification process ease of use, simple and without the risk of data leakage.

### SUMMARY OF THE INVENTION

The objective of the present invention is to provide an identification system using radio frequency and identification method for a HMI. An identification process of the human-machine interface (HMI) is executed via sensing radio frequency identification (RFID) tag without manually input passwords.

To realize the above objective, according to the present invention, a computer senses a RFID tag and compiles a password table according to the tag number of the RFID tag. The password table is downloaded to the HMI. An identification process is executed at the HMI by sensing a RFID tag via a radio frequency card reader, looking up if matching tag number with the sensed RFID tag is recorded in the downloaded password table. If yes, HMI uses the identification password corresponding to the tad number in the password table for executing identification process.

Compare to the prior art, the present invention provides advantages that an administrator is allowed to assign an identification password and an operating authority to each RFID tag when configuring an operating screen of the HMI. The identification password and the operating authority are downloaded to the HMI along with the operating screen. Accordingly, the step sensing RFID tag is used for replacing manually input a password when a user desires to log on an HMI or instruct the HMI to switch to a particular operating screen. The user does not need to manually input the identification password such that the forget password scenario is avoided. Further, the risk of that the password is leaked to the third party as the user manually input the password is also avoided.

### BRIEF DESCRIPTION OF DRAWING

The features of the invention believed to be novel are set forth with particularity in the appended claims. The invention itself, however, may be best understood by reference to the following detailed description of the invention, which describes an exemplary embodiment of the invention, taken in conjunction with the accompanying drawings, in which:

FIG. 1 is an operating schematic diagram of a preferred embodiment according to the present invention;

FIG. 2 is a system block diagram of a preferred embodiment according to the present invention;

FIG. 3 is an configuring flow chart of a preferred embodiment according to the present invention; and

FIG. 4 is an identification flow chart of a preferred embodiment according to the present invention.

### DETAILED DESCRIPTION OF THE INVENTION

In cooperation with attached drawings, the technical contents and detailed description of the present invention are described thereinafter according to a preferable embodiment, being not used to limit its executing scope. Any equivalent variation and modification made according to appended claims is all covered by the claims claimed by the present invention.

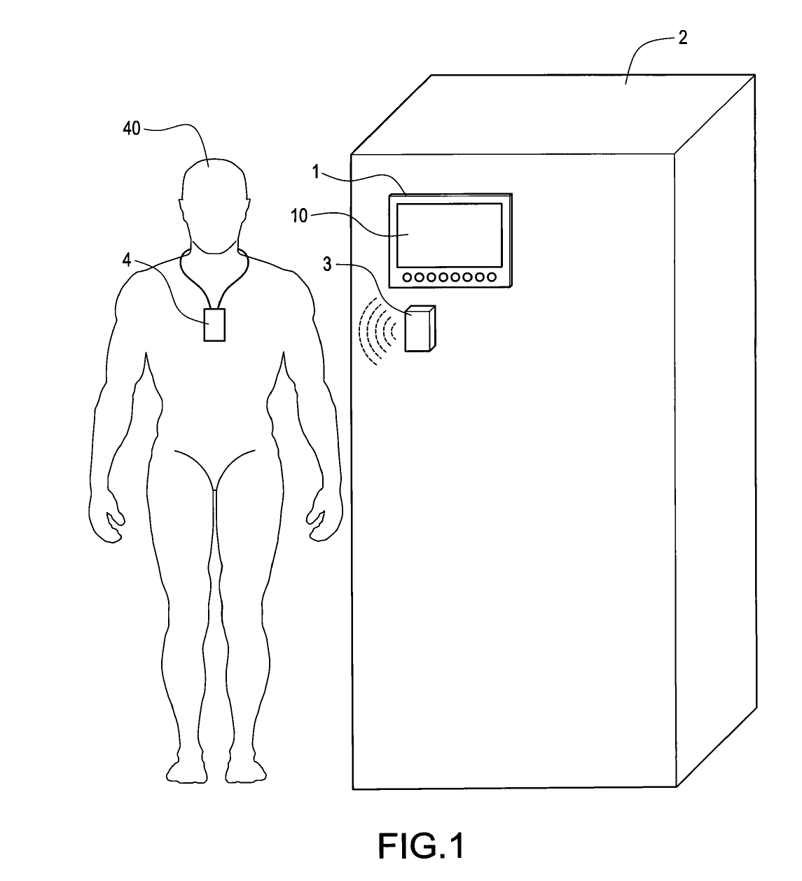

FIG. 1 is an operating schematic diagram of a preferred embodiment according to the present invention. As shown in the diagram, the present invention is used in a human-machine interface (HMI) 1. The HMI 1 is electrically connected to one or a plurality of mechanical equipments 2 for controlling series of automatic procedures of the mechanical equipments 2. The HMI 1 is further electrically connected to a radio frequency card reader 3 for sensing a radio frequency identification (RFID) tag 4. When an operator 40 desires to log on to the HMI 1 for executing operations, or instruct the HMI 1 to switch to a specific operating screen 10, the HMI 1 senses the RFID tag 4 on the operator 40 via the radio frequency card reader 3 for executing identification process. The operator logs onto the HMI 1 or instruct the HMI 1 to switch to the specific operating screen 10 (for example, a screen assigning critical parameters or a browser screen having confidential data) after passing the identification process.

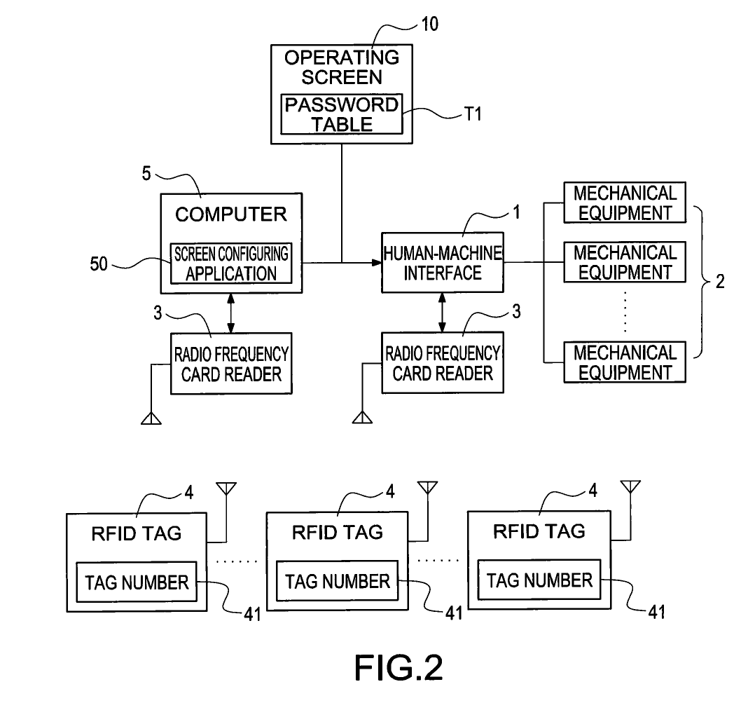

FIG. 2 is a system block diagram of a preferred embodiment according to the present invention. The identification system of the present invention comprises the HMI 1, the radio frequency card reader 3 and a computer 5. The computer 5 is electrically connected to the radio frequency card reader 3. Additionally, a screen configuring application 50 is installed in the computer 5 for configuring the operating screen 10 of the HMI 1. The computer 5 retrieves a tag number 41 of the RFID tag 4 via the radio frequency card reader. When configuring the operating screen 10, a user can compile a password table T1 at the same time. Upon the operating screen 10 is configured and the password table T1 is compiled, the computer 5 is electrically connected to the HMI 1, the completed operating screen 10 and the password table T1 are downloaded to the HMI 1 and the operating screen 10 and the password table T1 are saved in the HMI 1.

The HMI 1 is connected to one or multiple mechanical equipments 2 and is further electrically connected to the radio frequency card reader 3. When the HMI 1 proceeds to execute an identification process, the HMI 1 senses the RFID tag on the operator 40 (as shown in FIG. 1) via the radio frequency card reader 3 for retrieving the tag number 41 recorded in the RFID tag 4. The tag number 41 is compared with the tag numbers in the downloaded password table T1 for executing identification process (detailed in the following). Upon the identification is completed, the operator 40 is permitted to log on to the HMI 1, or instruct the HMI 1 to switch to the specific operating screen 10.

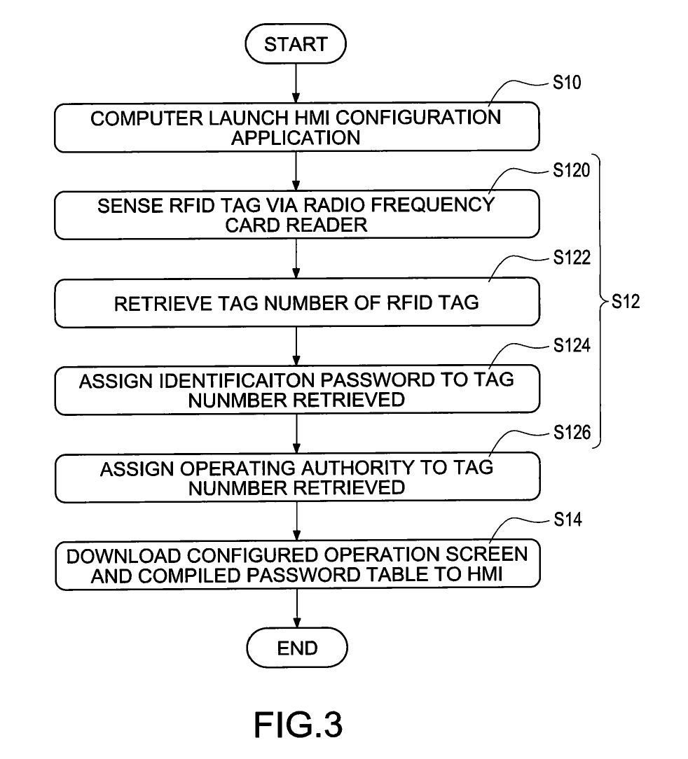

FIG. 3 is an configuring flow chart of a preferred embodiment according to the present invention, According to the present invention, the password table T1 is compiled in the computer 5 and downloaded to the HMI 1 for executing the identification process. Firstly, the computer 5 launches the screen configuring application 50 installed (step S10), for configuring the operating screen 10 of the HMI 1. Additionally, upon configuring the operating screen 10, the method proceeds to step S12 for compiling the password table T1. The step S12 further comprises step S120 to step S126 detailed in the following.

The computer 5 senses the RFID tag 4 (step S120) for retrieving the tag number 41 recorded in the RFID tag 4 via the radio frequency card reader 3 (step S122). Following step S122, the computer 5 respectively assigns an identification password P1 to each tag number 41 (step S124) (as shown in the following table). In addition, each tag number 41 is respectively assigned an operating authority O1 as required by the scenario (step S126) (as shown in the following table). Depending on administrator's requirements, the password table T1 records the tag number 41 and the identification password P1. Or, the password table T1 records the tag number 41, the identification password P1 and the operating authority O1. In the following example, the password table T1 records the tag number 41, the identification password P1 and the operating authority O1. It should be noted that the scope of the invention is not limited to the example.

Following the step S12, the computer 5 downloads the configured operating screen 10 along with the compiled password table T1a to the HMI 1 (step S14).

The computer 5 repeats executing the step S12 for retrieving all tag numbers 41 of the RFID tag 4. Further, the computer 5 respectively assigns the corresponding identification password P1 and the operating authority O1 for all tag numbers 41 in the password table T1. The password table T1 is listed in the following:

| tag | identification | operating |
|---|---|---|
| number 41 | password P1 | authority O1 |
| 0 | 123456 | 1 |
| 1 | abcdef | 2 |
| 2 | 123456 | 1 |
| 3 | XXXXXX | 3 |

For example, the computer 5 senses four RFID tags 4 via the radio frequency card reader 3 and is acknowledged of the tag number 41 of the RFID tags 4 respectively as “0”, “1”, “2” and “3”. The computer 5 respectively assigns corresponding identification password P1 and the operating authority O1 to each tag number 41. The corresponding identification password P1 of the two RFID tags 4 having the tag number 41 as “0” and “2” is both assigned as “123456”. The computer 5 further assigns the corresponding operating authority O1 of the two tag numbers 41 both as “1”. Accordingly, when the HMI 1 senses the two RFID tags 4, the HMI uses exactly the same identification password P1 for executing the identification process. Upon the identification process is completed, the same operating authority O1 is generated. However, the example described above is one of the preferred embodiments, the password table T1 can be assigned subject to user requirements. Also expressions of the tag number 41, the identification password P1 and the operating authority O1 can vary as the developer desires and should not be limited thereto.

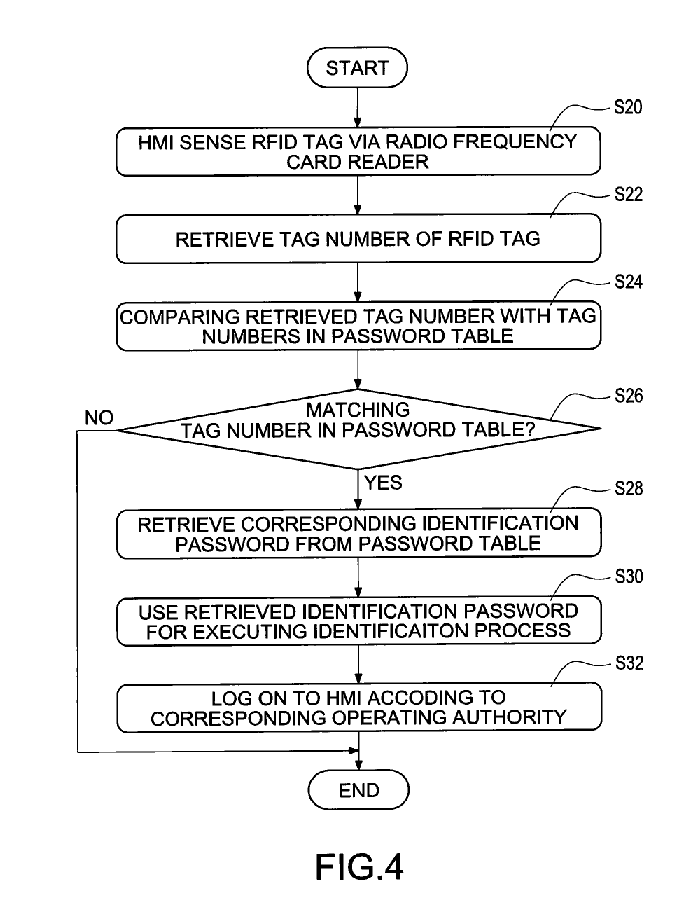

FIG. 4 is an identification flow chart of a preferred embodiment according to the present invention. The operating screen 10 and the password table T1 generated by the computer 5 is received, saved and executed by the HMI 1. When the HMI 1 proceeds to executing the identification process, the HMI 1 senses the RFID tag 4 via the radio frequency card reader 3 (step S20) for retrieving the tag number 41 recorded in the RFID tag 4 (step S22). Next, the HMI 1 compares the tag number 41 with tag numbers in the downloaded password table T1 (step S24), and determines if any tag number recorded in the password table T1 matches the tag number 41 (step S26). If there is not any tag number recorded in the password table T1 matching with the tag number 41, that indicates the RFID tag 4 is not assigned in step S12. As a result, the RFID tag 4 fails to pass the identification process.

Following step S26, if there is a tag number recorded in the password table T1 matching with the tag number 41, then the HMI 1 retrieves the identification password P1 of the tag number 41 from the password table T1 (step S28). Also, following the step S28, the identification password P1 is used for executing identification process of the HMI 1 (step S30). Upon the identification is completed, the HMI 1 retrieves the operating authority O1 corresponding to the tag number 41 from the password table T1, and the HMI is logged on according to the operating authority O1 (step S32), or instruct the HMI 1 to switch to the specific operating screen 10.

As the skilled person will appreciate, various changes and modifications can be made to the described embodiments. It is intended to include all such variations, modifications and equivalents which fall within the scope of the invention, as defined in the accompanying claims.

1. A human-machine interface (HMI) identification system using radio frequency comprising:
a radio frequency card reader;
a computer electrically connected to the radio frequency card reader and retrieving a tag number of the radio frequency identification (RFID) tag via the radio frequency card reader, the computer sensing a RFID tag and compiling a password table according to the tag number, wherein the tag number and an identification password corresponding to the tag number are recorded in the password table;
a human-machine interface electrically connected to the computer and downloading the password table compiled by the computer;
wherein, the HMI is electrically connected to the radio frequency card reader, for sensing the RFID tag and retrieving the tag number of the RFID tag, if a matching tag number of the RFID tag is recorded in the password table downloaded by HMI, the HMI uses the identification password corresponding to the tag number in the password table for executing the identification process.

2. The HMI identification system using radio frequency of claim 1, wherein the HMI is electrically connected to the radio frequency card reader via a Universal Serial Bus.

3. The HMI identification system using radio frequency of claim 1, wherein the HMI is electrically connected to the radio frequency card reader via a RS-232 interface.

4. The HMI identification system using radio frequency of claim 1, wherein operating authority corresponding to the RFID tag is further recorded in the password table and the log on process is performed according to the operating authority upon the identification process is completed at the HMI.

5. The HMI identification system using radio frequency of claim 1, wherein the computer has a screen configuring application of the HMI, configures the operating screen and compiles the password table of the HMI via the screen configuring application, and downloads the operating screen and the password table to the HMI upon the configuring and compilation is completed.

6. An identification method using radio frequency for a human-machine interface (HMI), wherein the HMI electrically connected to a radio frequency card reader, the HMI identification method comprising:
a) sensing a RFID tag via the radio frequency card reader at the HMI;
b) retrieving a tag number of the RFID tag;
c) comparing the tag number in a password table in the HMI;
d) determining if any matching tag number is recorded in the password table;
e) if yes, using an identification password corresponding to the tag number in the password table for executing the identification process at HMI following step d.

7. The HMI identification method using radio frequency of claim 6, further comprising a step a0 prior to step a: providing a computer electrically connected to the HMI, compiling the password table and downloading the password table to the HMI.

8. The HMI identification method using radio frequency of claim 6, further comprising steps prior to the step a:
a01) connecting electrically a computer to the radio frequency card reader and sensing the RFID tag via the radio frequency card reader;
a02) retrieving the tag number of the RFID tag;
a03) assigning an identification password of the tag number for compiling the password table;
a04) downloading the compiled password table to the HMI.

9. The HMI identification method using radio frequency of claim 8, further comprising a step a05: assigning operating authority of the tag number and compiling the password table with the tag number, the identification password and the operating authority prior to the step a04.

10. The HMI identification method using radio frequency of claim 9, further comprising a step f after the step e: logging on to the HMI according to the operating auth1.
